(19) United States
(12) Patent Application Publication
(10) Pub. No.: US 2004/0179064 A1
(43) Pub. Date: Sep. 16, 2004

(54) Nozzle plate for droplet deposition apparatus

(76) Inventors: Werner Zapka, Jarfalla (SE); Robert Harvey, Cambridge (GB); Stephen Temple, Cambridge (GB); Salhadin Omer, Cambridge (GB); Paul R Drury, Royston (GB)

Correspondence Address: Marshall Gerstein & Borun, 6300 Sears Tower, 233 South Wacker Drive, Chicago, IL, 60606-6357, US

(21) Appl. No.: 10/479,473

(22) PCT Filed: Jun. 5, 2002
(86) PCT No.: PCT/GB02/02615

(30) Foreign Application Priority Data
Jun. 5, 2001 (GB) 0113639.9

(51) Int. Cl. B41J 2/14

(52) U.S. Cl. 347/47

(57) ABSTRACT

A nozzle plate includes a body and an insert formed of polymeric material. Each nozzle has an inlet, an outlet, and a bore extending between the inlet and the outlet and formed through the polymeric material of the insert located within an aperture formed in a body of the nozzle plate.

This invention relates to a nozzle plate for droplet deposition apparatus.

A nozzle plate is typically attached to a body of a droplet deposition apparatus having a plurality of ink ejection chambers to provide each chamber with a respective droplet ejection nozzle. Due to the accuracy with which ejection nozzles must be formed in the nozzle plate, for example to ensure uniformity of the size and velocity of droplets ejected from the ejection chambers, laser ablation is commonly used to form the nozzles in the nozzle plate. Plastics material such as polyimide, polysulphone or other such laser-ablatable plastics material is commonly used to form the nozzle plate, and after the application of an ink-repellant layer to one face of the nozzle plate, each nozzle is formed by exposing the plate to a laser beam, such as an excimer laser beam, of appropriate diameter. The nozzle plate, complete with nozzles, is then bonded to the body of the apparatus with each nozzle aligned with a respective chamber formed in the body.

The use of plastics material for the nozzle plate tends to make the nozzle plate relatively weak, and thus prone to mechanical damage. Whilst stiffer materials, such as metallic or ceramics material, may be used for the nozzle plate, accurate nozzles are less readily formed in the nozzle plate.

In its preferred embodiments the present invention seeks to solve these and other problems.

In a first aspect the present invention provides a nozzle plate for droplet deposition apparatus, the nozzle plate comprising a body and a plurality of nozzles, each nozzle having an inlet, an outlet and a bore extending between the inlet and the outlet and formed through polymeric material located within an aperture formed in the body.

This can enable the body of the nozzle plate to be formed from relatively stiff material, such as plastic, metallic or ceramic material, whilst still enabling the nozzles to be readily and accurately formed in the polymeric material.

Preferably, the polymeric material comprises one of epoxy resin, parylene, polyimide or a thermoplastic. The body may be formed from metallic material, for example, from an alloy comprising nickel and iron, such as Nilo, or from ceramic material, such as PZT, alumina or zirconia.

The bore preferably converges towards the outlet. In one embodiment, a layer of the polymeric material extends over a bonding surface of the body. When this surface is bonded or otherwise mounted on the droplet deposition apparatus, the layer of polymeric material can serve to electrically insulate the body from the remainder of the apparatus.

The outlet may be recessed relative to a surface of the body. This can protect the outlet from mechanical damage.

This aspect of the present invention extends to droplet deposition apparatus comprising a plurality of channels and a nozzle plate as aforementioned mounted on the apparatus to provide each channel with a respective nozzle for the ejection of droplets therethrough.

The apparatus may comprise a base with channel separating side walls extending from the base to define said channels, the nozzle plate being mounted on the surfaces of the side walls opposite the base. The nozzle plate can thus act as a cover plate for such droplet deposition apparatus; it has hitherto been necessary with such “edge shooter” apparatus, in which droplets are ejected from the top of ink channels, to utilise both a relatively stiff cover plate and a plastics nozzle plate mounted on the cover plate, and thus the present invention can enable the number of components required to form the apparatus to be reduced. Preferably, the body of the nozzle plate is formed from material having a coefficient of thermal expansion substantially equal to that of the side walls.

In a second aspect the present invention provides a method of manufacturing a nozzle plate for droplet deposition apparatus, said method comprising the steps of forming an aperture in a body, introducing into the aperture polymeric material, and forming in the polymeric material a nozzle having an inlet, an outlet and a bore extending through the polymeric material between said inlet and outlet.

The aperture may be formed in the body preferably by etching, or otherwise by any other suitable process, such as laser cutting, mechanical drilling, punching and electroforming. Preferably the polymeric material is introduced into the aperture using a moulding technique, preferably so as to substantially fill the aperture.

The method preferably comprises the step of forming a recess in the polymeric material. Recessing the polymeric material relative to a surface of the body can serve to shield the nozzle outlet from mechanical damage during use.

In one embodiment, the method comprises the steps of applying a compliant surface to a surface of the body and pressing the body against the compliant surface so as to cause the compliant surface to deform into the aperture and thereby recess the polymeric material. This can provide a relatively simple and controllable mechanism for forming the recess.

The nozzle may be formed at least in part by laser ablation. Preferably, prior to the formation of the nozzle, a protective layer is applied to the surface of the polymeric material in which the outlet is to be formed. This can effectively protect the surface, in particular at the periphery of the zone in which material removal takes place, from high energy free radical ablation products. The protective layer may be releasably bonded to said surface, advantageously by the use of an adhesive layer. Preferably, the protective layer is itself ablatable. Further details of the protective layer are described in our International patent application WO96/08375, the contents of which are incorporated herein by reference.

Alternatively, the nozzle may be formed at least in part by hot pressing, or forging, for example, by pressing a die having a profile conforming to that of the nozzle into the polymeric material. In a preferred embodiment a plurality of nozzles are simultaneously formed using a die having a plurality of profiled portions, and wherein each portion is pressed into a respective plug formed in the body to form a nozzle in said plug. This can enable the nozzle plate to be manufactured more quickly.

Whilst the profiled portion may punch polymeric material from the aperture to form a nozzle having a substantially cylindrical bore, the extent of the closure of the profiled portion within the polymeric material is preferably limited to control the shape of the nozzle formed in the polymeric material. This can enable a bore to be formed which converges towards the outlet of the nozzle.

Preferably the die has a substantially planar portion extending about said profiled portion so that polymeric material forced from the aperture during said pressing forms a layer of polymeric material between said planar portion and a surface of said body. When this surface is bonded or otherwise mounted on the droplet deposition apparatus, the layer of polymeric material can serve to electrically insulate the body from the remainder of the apparatus.

In another embodiment the polymeric material comprises material curable upon exposure to electromagnetic radiation, and the nozzle is formed by selectively exposing material to electromagnetic radiation and removing non-exposed material to form said nozzle.

In yet another embodiment, the nozzle is formed at least in part during the moulding of the polymeric material in the aperture. The method may comprise the step of inserting a mould having a profile conforming to that of the nozzle into the aperture in the body, injecting polymeric material between the mould and the periphery of the aperture in the body, and subsequently removing the mould. Preferably a plurality of nozzles are simultaneously formed in the body. In a preferred embodiment each nozzle is formed using a single mould, the mould having a plurality of profiled portions, and wherein each portion is inserted into a respective aperture formed in the body and polymeric material is injected between each profiled portion and the periphery of the respective aperture to form said nozzles. The mould may include a substantially planar portion extending about said profiled portion, one or more spacers being located between the planar portion and a surface of the body so that polymeric material is also injected into the space defined between said surface and said planar portion to form a layer of polymeric material on said surface.

The nozzles may be formed by any combination of the above techniques, for example by partially forming the nozzle by moulding or hot pressing of the polymeric material in the aperture, and completing the formation of the nozzle by laser ablation.

The method preferably comprises the step of forming a liquid-repellant layer extending about said outlet. This layer maybe formed prior to, or subsequent to, the formation of the nozzle, although it is preferred that this layer is formed prior to the formation of the nozzle in order to avoid blockage of the nozzle outlet by forming the layer after nozzle formation.

In a further embodiment a layer of polymeric material, for example parylene, is formed within the aperture, for example, using a coating technique, so as to form a first part of said nozzle. Prior to formation of said layer of polymeric material, a cover plate is mounted over the aperture formed in said body. Subsequent to the formation of said layer, an aperture substantially co-axial with the nozzle bore is formed in said cover plate, preferably using a laser ablation technique, to form a second part of the nozzle. An additional layer of polymeric material may be formed on the surface of the cover plate opposite said body. The cover plate may be formed from plastics material. Preferably, a portion of the additional layer of polymeric material extending about said co-axial aperture is selectively removed following formation of said co-axial aperture. A mask used in this selective removal of material may be mounted on the cover so to protect the outlet of this additional aperture from mechanical damage. The mask may be formed from metallic material, such as an alloy of nickel and iron.

The nozzles may be formed in the nozzle plate subsequent to the attachment of the nozzle plate to the droplet deposition apparatus, and thus the nozzle plate may be supplied without nozzles in the form of a nozzle plate blank. Accordingly, the present invention extends to a nozzle plate blank for droplet deposition apparatus, the blank comprising a body having a plurality of apertures formed therein, polymeric material being located in each aperture. The blank may comprise a bore formed partially through the polymeric material to define part of a nozzle within each aperture of said nozzle plate. The bore may be tapered. By providing a blank with partially formed nozzles, this can enable the nozzle formation to be quickly completed by, for example, laser ablation, which can improve the quality of the nozzle outlet.

Preferred features of the present invention will now be described with reference to the accompanying drawings, in which:

FIG. 1 is a cross-sectional view of a nozzle formed in a nozzle plate;

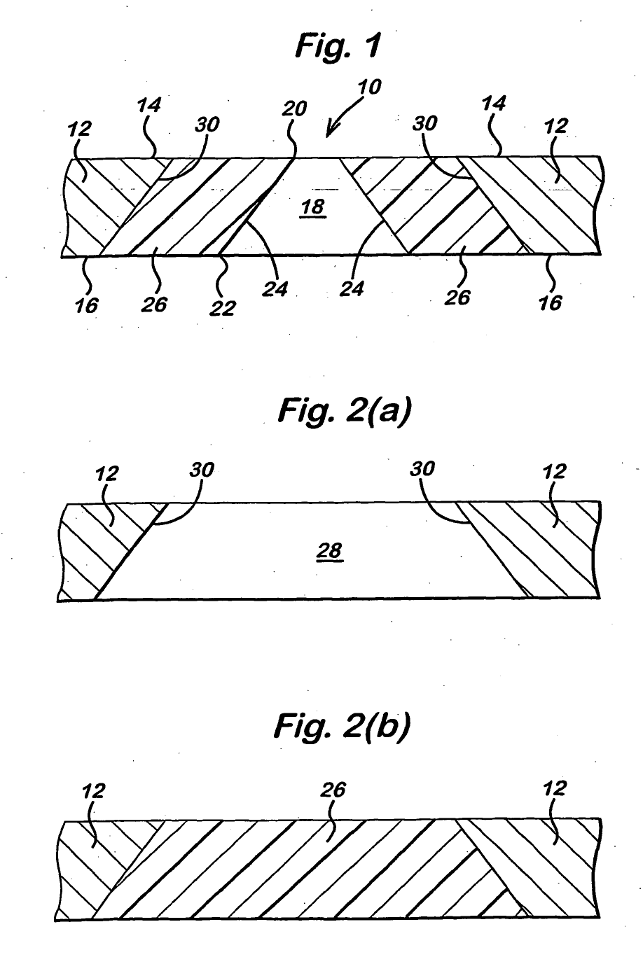

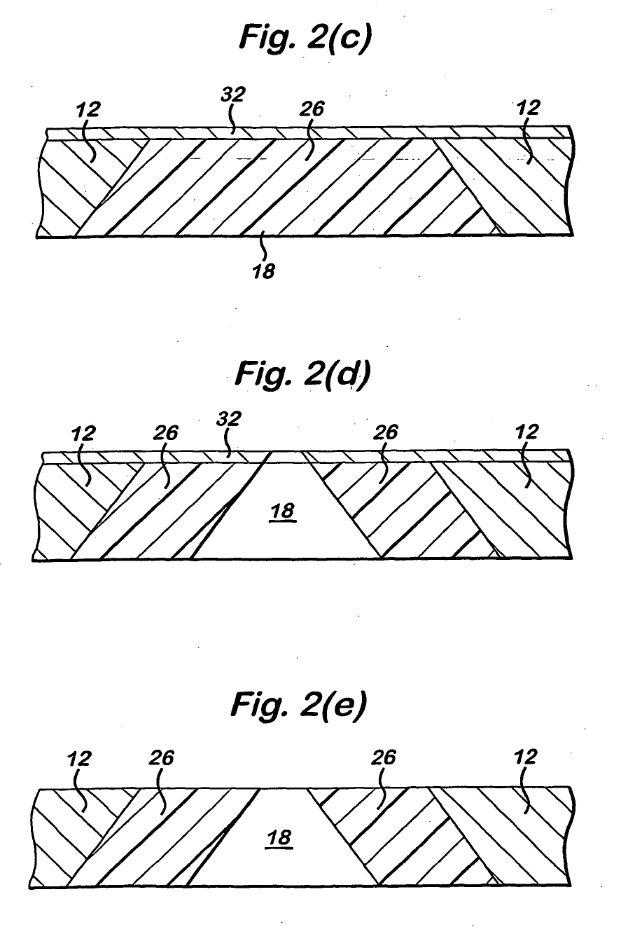

FIGS. 2(a) to 2(e) are cross-sectional views illustrating steps in a first embodiment of a method of manufacturing the nozzle plate;

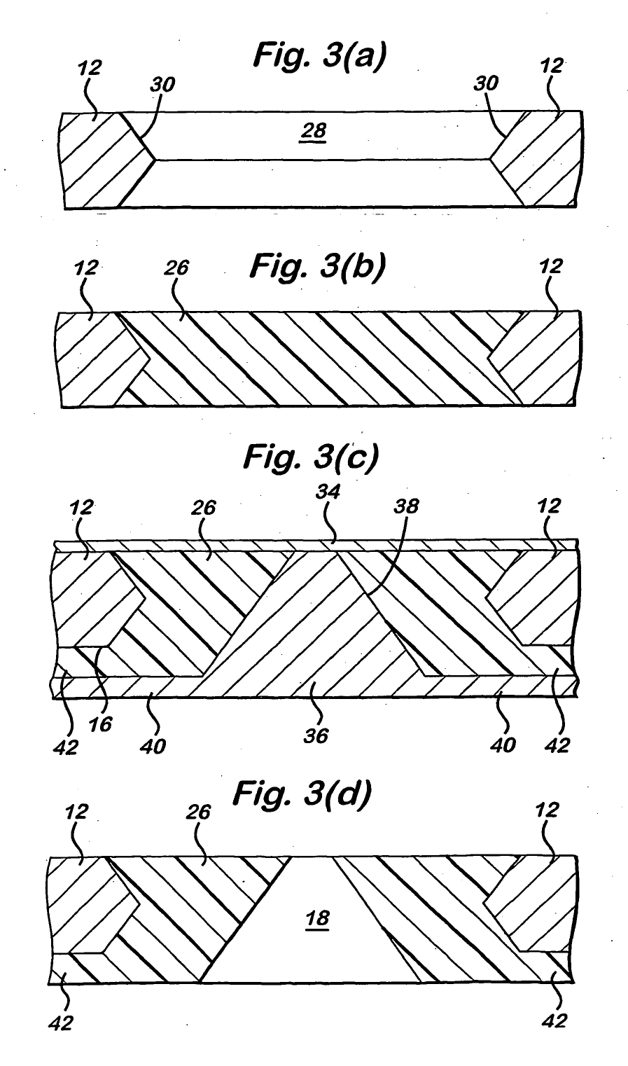

FIGS. 3(a) to 3(d) are cross-sectional views illustrating steps in a second embodiment of a method of manufacturing the nozzle plate;

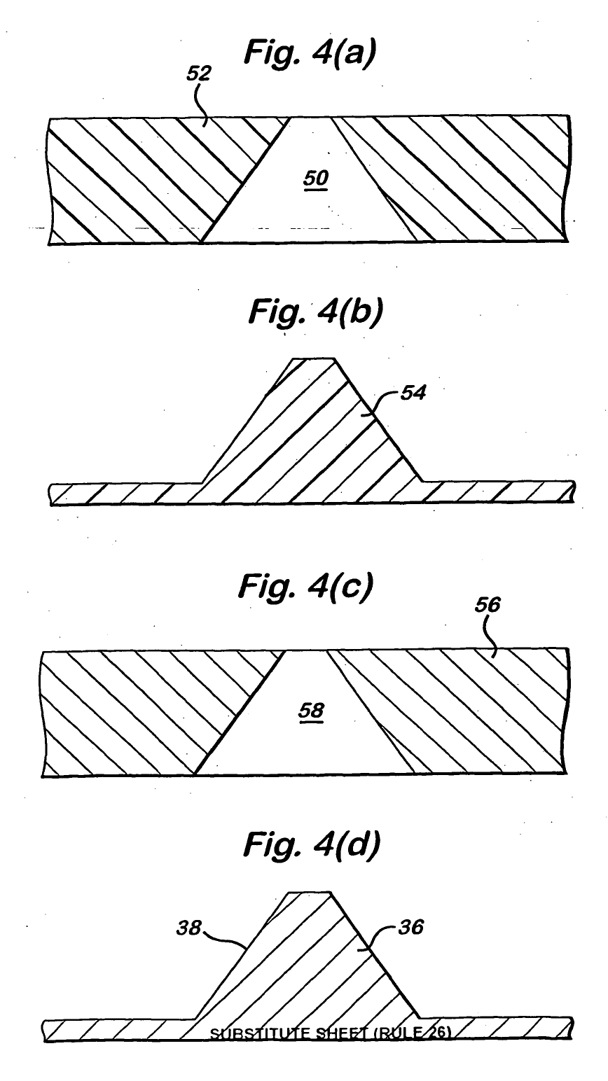

FIGS. 4(a) to 4(d) are cross-sectional views illustrating steps in a method of manufacturing a die for use in the second embodiment;

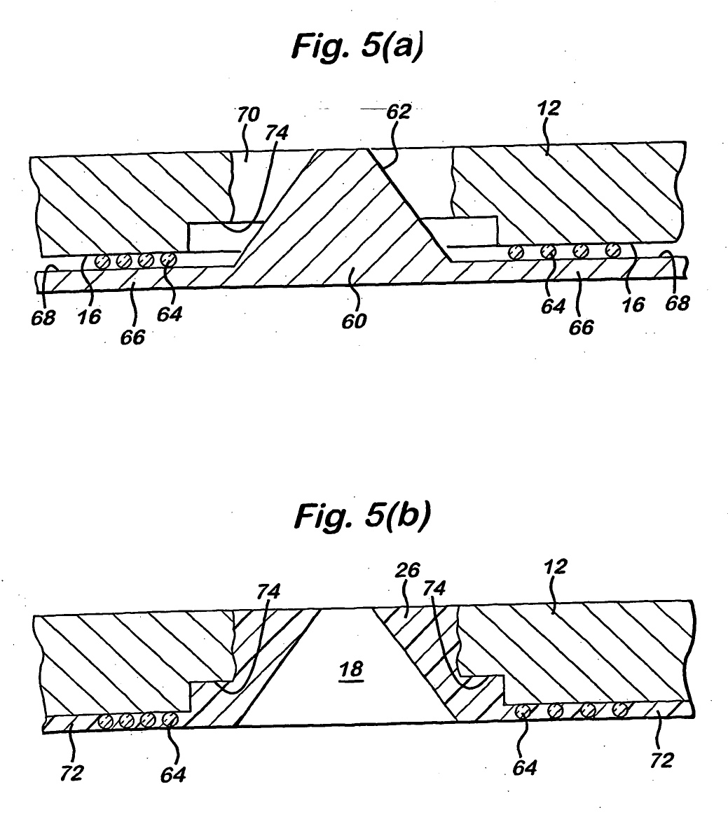

FIGS. 5(a) and 5(b) are cross-sectional views illustrating steps in a third embodiment of a method of manufacturing the nozzle plate;

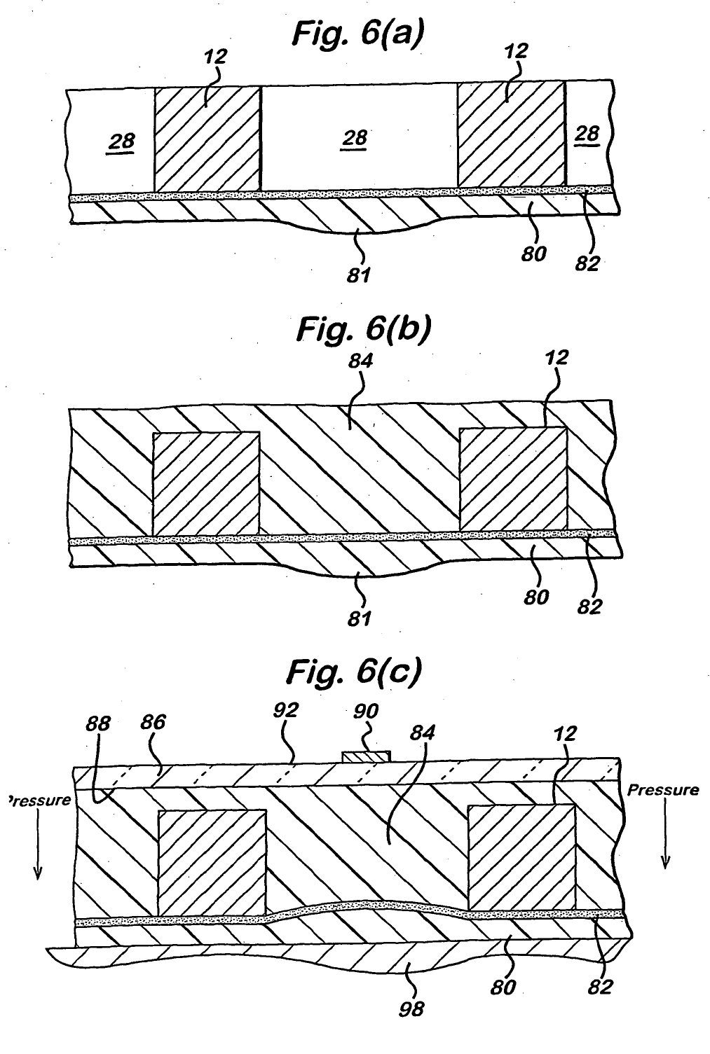

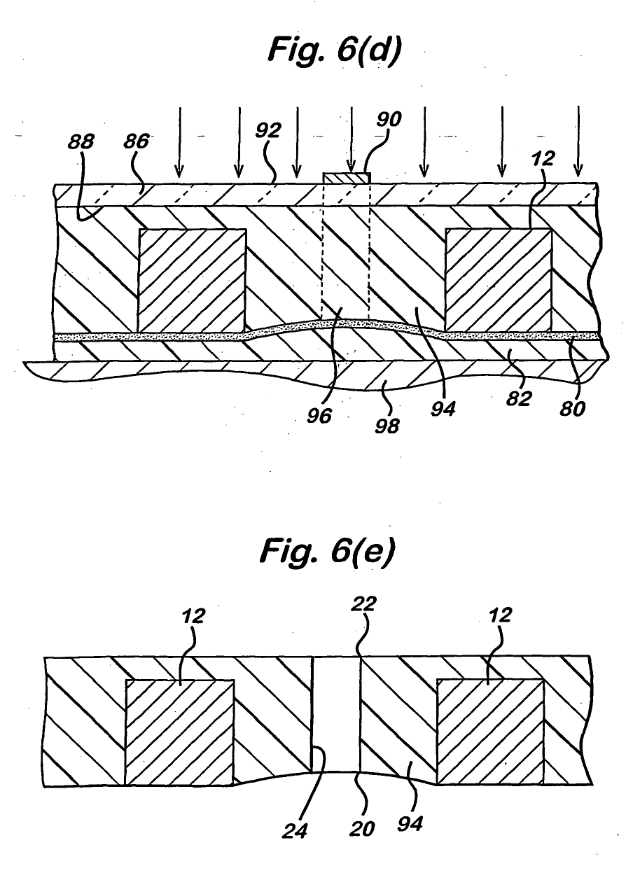

FIGS. 6(a) to 6(e) are cross-sectional views illustrating steps in a fourth embodiment of a method of manufacturing the nozzle plate;

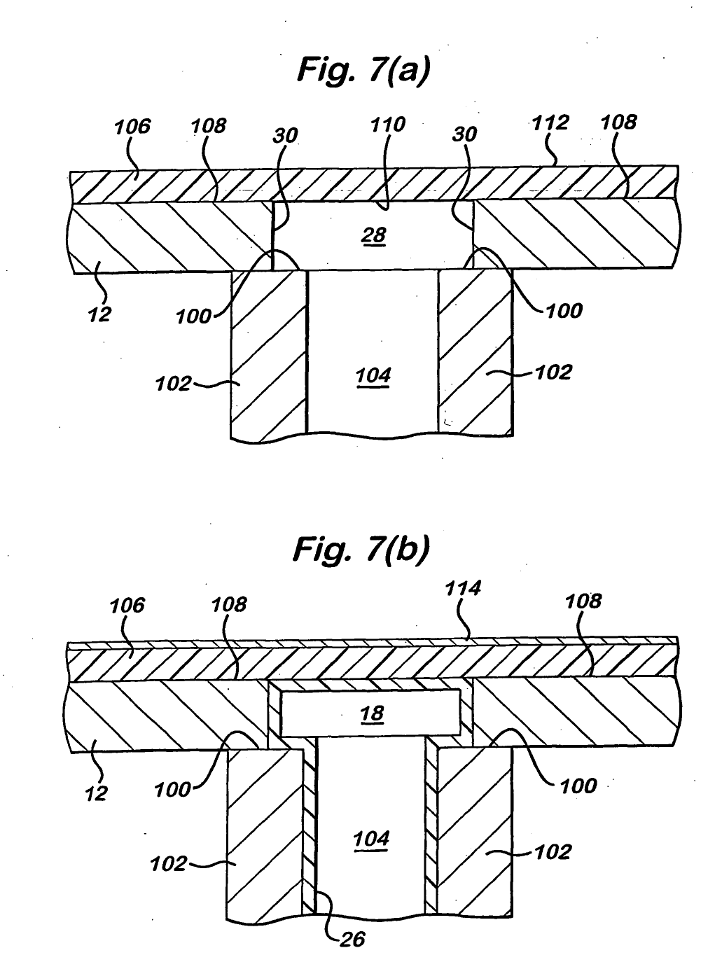

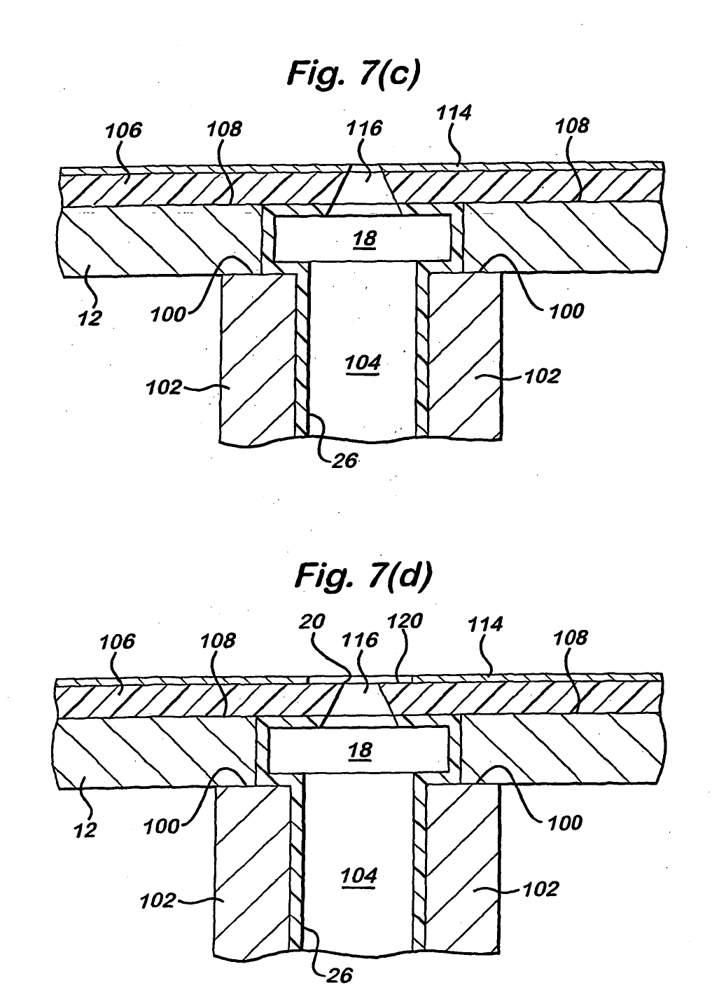

FIGS. 7(a) to 7(d) are cross-sectional views illustrating steps in a fifth embodiment of a method of manufacturing the nozzle plate; and

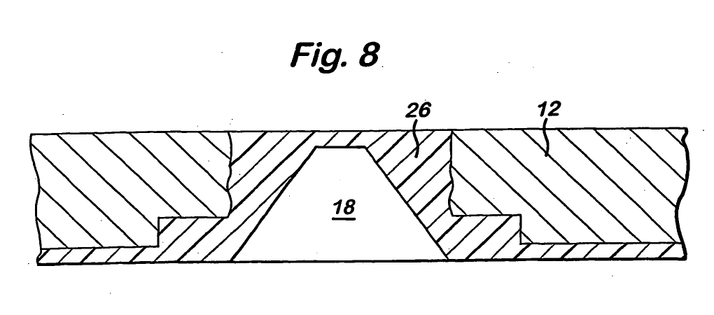

FIG. 8 is a cross-sectional view of a partially-formed nozzle formed in a nozzle plate.

With reference to FIG. 1, a nozzle plate 10 comprises a body 12 preferably in the form of a plate, having substantially parallel planar upper and lower surfaces 14 and 16. The lower surface 16 is intended to be mounted on droplet deposition apparatus, such as an inkjet printhead. The body 12 is preferably formed from metallic material, such as Nilo 42.

Within the body 12 are formed a series of apertures, one of which is shown in FIG. 1. In this embodiment, the pitch of the apertures is approximately 130 to 150 μm (corresponding th width of the channels in the droplet deposition apparatus to which the plate is to be applied), the width of the mouth of the aperture at the upper surface 14 is around 100 μm and the depth of the aperture is around 100 μm.

Within each aperture is formed a nozzle 18, the nozzle having an outlet 20, an inlet 22 and a bore 24 which converges towards the outlet 22. The bore 24 of the nozzle 18 extends through an insert, or plug, 26 of polymeric material, such as epoxy resin, located in the aperture of the body 12. The nozzle outlet typically has a diameter of 50 μm or less, compared to an aperture width of around 100 μm at the upper surface 14. The width of the aperture may be increased if the tolerance of the nozzle within the aperture is increased.

Various embodiments of a method of manufacturing the nozzle plate will now be described with reference to the figures, each of which illustrates steps in the formation of a single nozzle only in the nozzle plate 10. It will become apparent that each of the embodiments may be used to form a plurality of nozzles in the nozzle plate.

FIGS. 2(a) to 2(e) are cross-sectional views illustrating steps in a first embodiment of a method of manufacturing the nozzle plate. First, with reference to FIG. 2(a), an aperture 28 is formed in the body 12. As the walls 30 of the aperture 28 do not need to be formed with a high degree of accuracy, a relatively quick and simple technique, such as chemical etching, may be used to form simultaneously a plurality of such apertures 28 in the body 12. Next, as shown in FIG. 2(b), a plug 26 of epoxy resin is located in the aperture 28. The plug 26 may be formed by any suitable method, such as injection moulding. A liquid-repellant layer, formed from low surface energy material such as fluorinated ethylene propylene copolymer (FEP), may optionally be applied to the upper surface of the body 12 and the upper surface of the plug at this stage. With reference to FIGS. 2(c) and 2(d), a protective layer 32, for example, a parylene ablation protection tape, may then be applied and a tapered nozzle 18 accurately formed in the plug 26 by laser ablation. Details of the ablation process and the protective layer are described in our International patent application WO96/08375, the contents of which are incorporated herein by reference. Following ablation, the protective layer 32 is removed, as shown in FIG. 2(e). The use of a protective layer 32 is optional, as, for example, the FEP liquid-repellant layer can act alone as a protective layer for the laser ablation.

As the body 12 of the nozzle plate 10 is formed from material, such as Nilo 42, which is relatively stiff in comparison to the epoxy resin, the nozzle plate 10 is more robust than prior nozzle plates formed solely from laser ablatable plastics material. Accordingly, the nozzle plate 10 is suitable for use as a cover for “edge shooter” droplet deposition apparatus, in which droplets are ejected from the tops of ink channels, as well as for use as a nozzle plate for “end shooter” apparatus, in which droplets are ejected from the ends of ink channels. This mechanical advantage provided by forming the body of the nozzle plate from metallic material is coupled with the advantage of the relative ease and accuracy with which nozzles may be formed in the plugs of epoxy resin located in the body of the nozzle plate.

In the above embodiment, a series of apertures may be simultaneously formed in the body 12 of the nozzle plate, plugs of epoxy resin may be simultaneously formed in apertures, and laser ablation used to form sequentially the nozzle in each plug of epoxy resin. In the following further embodiments, in order to reduce the time required to form the nozzles, the nozzles are also simultaneously formed in the plugs of epoxy resin.

FIGS. 3(a) to 3(d) are cross-sectional views illustrating steps in a second embodiment of a method of manufacturing the nozzle plate. Similar to the first embodiment, an aperture 28 is formed in the body 12 and a plug 26 of epoxy resin formed in the aperture 28, as illustrated in FIGS. 3(a) and 3(b). A liquid-repellant layer may optionally be applied to the upper surface of the body 12 and the upper surface of the plug 26 at this stage. As illustrated in FIG. 3(c), in this embodiment an abutment surface 34 is applied to the upper surface of the body 12 and the upper surface of the plug 26. A die 36 is then pressed or otherwise urged into the plug. The die 36 comprises a profiled portion 38 and a substantially planar portion 40 surrounding the profiled portion 38, the profiled portion 38 having a profile conforming to that of the nozzle to be formed in the plug. As the die is pressed into the plug, epoxy resin is forced from the plug to form a layer 42 of epoxy resin on the lower surface 16 of the body 12. The die is pressed into the plug until the profiled portion contacts the abutment surface 34, as shown in FIG. 3(c), thereby controlling the shape of the nozzle formed in the plug by the die. The die is then withdrawn, and the abutment surface 34 removed to complete the formation of the nozzle 18 in the nozzle plate, as shown in FIG. 3(d).

In this embodiment, a single die having a plurality of profiled portions 38 can be used to form simultaneously a plurality of nozzles by pressing each profiled portion into a respective plug formed in the body of the nozzle plate. Furthermore, a layer 42 of epoxy resin is formed on the lower surface of the body 12 of the nozzle plate. This can serve to electrically insulate the body of the nozzle plate from the droplet deposition apparatus upon attachment of the nozzle plate to the apparatus.

FIGS. 4(a) to 4(d) are cross-sectional views illustrating steps in a method of manufacturing a die for use in the second embodiment. Whilst the figures illustrate the formation of a die having a single profiled portion, the method can be extended to the formation of a die having a plurality of similar such profiled portions joined by a substantially planar portion.

First, an aperture 50 is accurately formed using a laser ablation technique in a plate 52 of relatively soft material, such as plastics material. As illustrated in FIG. 4(a), the aperture 50 is formed with a profile which conforms to that of the nozzle 18 to be formed in the nozzle plate 10. This plate 52 is then used as a mould for the formation of a first die 54, as illustrated in FIG. 4(b), from similar plastics material by, for example, an injection moulding technique. The die 54 has a profile corresponding to that of the die 36 to be ultimately formed. Metallic material is then deposited on the die 54, for example, using an electroplating technique, to form metallic plate 56 having an aperture 58 corresponding to that formed in the plate 52 by laser ablation. The die 54 is then removed to leave only the metallic plate 56, a shown in FIG. 4(c). A metallic die 36 is then formed on the metallic plate 56 using, for example, an electroforming technique, and the metallic plate 56 removed to leave the die 36. By forming the die using this method, the shape of the profiled portion 38 of the die 36 can be accurately controlled so that the nozzle formed in the plug of epoxy resin using the die has an accurate profile which corresponds to that of a nozzle formed by laser ablation.

A similar such die is used in a third embodiment of a method of manufacturing the nozzle plate, as illustrated in FIGS. 5(a) and 5(b). In this embodiment, as shown in FIG. 5(a) the body 12 having an aperture formed therein, is inserted into the die 60 so that the profiled portion 62 of the die 60 extends into the aperture formed in the body. Spacers 64, such as ceramic particles, are provided between a planar portion 66 of the die 60 and the lower surface 16 of the body in order to raise the lower surface 16 of the body 12 relative to the upper surface 68 of the planar portion 66. Epoxy resin is then injected into the space 70 defined between the die 60 and the body 12 to form both a plug 26 of epoxy resin having a nozzle extending therethrough in the aperture in the body 12 and a layer 72 of epoxy resin extending over the lower surface of the body 12. A channel 74 in the lower surface 16 of the body 12 assists the flow of resin during moulding.

FIGS. 6(a) to 6(e) are cross-sectional views illustrating steps in a fourth embodiment of a method of manufacturing the nozzle plate. In this embodiment, the body 12, having one or more apertures formed therein, for example, by photolithographic etching, is attached to a compliant layer 80, such as a pad of rubber or compliant plastics material, by an adhesive release film 82, as shown in FIG. 6(a). The compliant layer 80 has a region 81 of locally increased thickness. Polymeric material, in the form of a cationic ultra violet (UV) curable adhesive 84, is then applied over the upper surface of the body 12 so as to both fill the apertures 28 and extend over the upper surface of the body 12, as shown in FIG. 6(b). A glass mask 86, incorporating suitably sized and positioned glue guards (not shown) on the lower surface 88 thereof, is brought into contact with the adhesive 84 and pressure applied to the glass mask 86 in the direction of the arrows shown in FIG. 6(c) to cause the adhesive 84 to flow so as to reduce the thickness of the layer of adhesive 84 formed on the upper surface of the body 12 to a predetermined thickness, for example, 5 microns. The pressure applied to the glass mask also causes the compliant pad 80 to deform against hard surface 98 and move the region 81 into the aperture 28 formed in the body 12, as shown in FIG. 6(c), in order to recess the adhesive 84 located in the aperture 28. As also shown in FIG. 6(c) a mask pattern 90 is formed on the upper surface 92 of the glass mask. Whilst the pressure is held at a substantially constant level to hold the mask 86 in the position shown in FIG. 6(c), UV light from a UV source located above the glass mask 86 is directed towards the upper surface of the mask 86 so as to selectively expose the adhesive 84, as shown in FIG. 6(d). The portion 96 of adhesive lying directly beneath the mask pattern 90 is shielded from the UV light, whist the remainder 94 of adhesive is exposed to the UV light. The duration of the expose is sufficient to fully cure the remainder 94 of adhesive exposed to the UV light. At the end of the exposure, compliant pad 80, release film 82 and glass mask 86 are removed, and the portion 96 of unexposed, and therefore uncured, adhesive removed by flushing with a suitable fluid in order to form nozzle 18, having a substantially cylindrical bore 24 extending between an inlet 22 and a recessed outlet 20.

The formation of the nozzle 18 by a photolithographic process results in an accurate nozzle 18 being formed in the nozzle plate. As will be readily appreciated, this method may be used to simultaneously form a plurality of nozzles in the nozzle plate. Recessing the outlet 20 can reduce the likelihood of mechanical damage to the nozzle during use. The recessing-technique of this-embodiment-can also be employed in any of the first and third embodiments described above.

FIGS. 7(a) to 7(d) are cross-sectional views illustrating steps in a fifth embodiment of a method of manufacturing the nozzle plate. In this embodiment, as shown in FIG. 7(a) the body 12, having one or more apertures 28 formed therein, for example, by photolithographic etching, is attached to droplet deposition apparatus, specifically to the upper surfaces 100 of the side walls 102 of a channel 104 defined between the side walls 104 and a base (not shown) from which the side walls 102 extend. The apertures 28 may be formed in the nozzle plate prior to, or subsequent to, mounting of the body on the side walls. In this embodiment, a cover plate 106 is attached to the upper surface 108 of the body 12, the cover plate 106 being formed from plastics material, such as Upilex ™. With reference to FIG. 7(b), the walls 30 of the aperture 28, the facing side surfaces of the side walls 102 and the lower surface 110 of the cover plate 106 exposed by the aperture 28 are then coated with a layer of polymeric material 26, for example parylene, by any conventional coating technique in order to form part of a nozzle 18 having a substantially cylindrical bore extending within the parylene 26. At the same time, or otherwise, the upper surface 112 of the cover plate 106 is coated with a layer 114 of parylene. With reference to FIG. 7(c), an aperture 116 is subsequently formed in the cover plate 106, for example, using a laser ablation technique, to complete formation of the nozzle. Subsequently, a portion of the layer 114 surrounding the outlet 20 is selectively removed, for example using a plasma etching technique so as to reveal a portion 120 of the cover plate 106. A mask (not shown) used in the etching for exposing this portion 120 of the cover plate may remain mounted on the layer 114 so as to mechanically protect the outlet 20. This mask may be formed from the same material as the body 12, for example, an alloy of nickel and iron such as Nilo.

FIG. 8 is a cross-sectional view of a partially-formed nozzle l8 in a nozzle plate 12. The nozzle may be formed in part by any of the techniques described with reference to FIGS. 3 and 5, that is, by moulding or hot pressing. Laser ablation is used to complete the formation of the nozzle 18. This has been found to improve the surface quality of the nozzle outlet. Conveniently, a nozzle plate blank such as that shown in FIG. 8 may be bonded to an ink jet printhead prior to exposure to the excimer laser beam to complete nozzle formation, thereby permitting accurate alignment of the laser beam with the ink channel 104 in the printhead into which the nozzle is to open.

Each feature disclosed in the description, and/or the claims and drawings may be provided independently or in any appropriate combination. In particular a feature of a subsidiary claim may be incorporated in a claim for which it is not dependent.

1. A nozzle plate for droplet deposition apparatus, the nozzle plate comprising a body and a plurality of nozzles, each nozzle having an inlet, an outlet and a bore extending between the inlet and the outlet and formed through polymeric material located within an aperture formed in the body.

2. A nozzle plate according to claim 1, wherein the polymeric material comprises one of epoxy resin, parylene, polyimide or a thermoplastic.

3. A nozzle plate according to any preceding claim, wherein the body is formed from one of metallic and ceramic material.

4. A nozzle plate according to claim 3, wherein the body is formed from an alloy comprising nickel and iron.

5. A nozzle plate according to any preceding claim, wherein the bore converges towards the outlet.

6. A nozzle plate according to any preceding claim, wherein a layer of said polymeric material extends over a bonding surface of the body.

7. A nozzle plate according to any preceding claim, wherein the outlet is recessed relative to a surface of the body.

8. A nozzle plate according to any preceding claim, comprising a liquid-repellant layer extending about said outlet.

9. A nozzle plate according to any preceding claim, comprising a cover plate mounted on the body, the nozzle bore extending through said cover plate.

10. Droplet deposition apparatus comprising a plurality of channels and a nozzle plate according to any preceding claim mounted on the apparatus to provide each channel with a respective nozzle for the ejection of droplets therethrough.

11. Apparatus according to claim 10, comprising a base and channel separating side walls extending from the base to define said channels, the nozzle plate being mounted on the surfaces of the side walls opposite the base.

12. Apparatus according to claim 11, wherein the body of the nozzle plate is formed from material having a coefficient of thermal expansion substantially equal to that of the side walls.

13. A method of manufacturing a nozzle plate for droplet deposition apparatus, said method comprising the steps of forming an aperture in a body, introducing into the aperture polymeric material, and forming in the polymeric material a nozzle having an inlet, an outlet and a bore extending between said inlet and outlet through the polymeric material.

14. A method according to claim 13, wherein the aperture is formed in the body by one of etching, laser cutting, drilling, punching and electroforming.

15. A method according to claim 13 or 14, wherein the polymeric material is introduced into the aperture using a moulding technique.

16. A method according to any of claims 13 to 15, wherein the polymeric material is introduced into the aperture so as to substantially fill the aperture.

17. A method according to any of claims 13 to 16, comprising the step of forming a recess in the polymeric material.

18. A method according to claim 17, comprising the steps of applying a compliant surface to a surface of the body and pressing the body against the compliant surface so as to cause the compliant surface to deform into the aperture and thereby recess said polymeric material.

19. A method according to any of claims 13 to 18, wherein the nozzle is formed at least in part by hot pressing.

20. A method according to any of claims 13 to 19, wherein the nozzle is formed by pressing a die having a profile conforming to that of the nozzle into the polymeric material.

21. A method according to claim 20, wherein the extent of the closure of the profiled portion within the polymeric material is limited to control the shape of the nozzle formed in the polymeric material.

22. A method according to claim 20 or 21, wherein said die has a plurality of profiled portions, and wherein each portion is pressed into a respective plug of polymeric material formed in the body to form a nozzle in said plug and thereby form simultaneously a plurality of nozzles.

23. A method according to any of claims 20 to 22, wherein the die has a substantially planar portion extending about said profiled portion so that polymeric material forced from the aperture during said pressing forms a layer of polymeric material between said planar portion and a surface of said body.

24. A method according to any of claims 13 to 23, wherein the nozzle is formed at least in part by laser ablation.

25. A method according to claim 24, wherein, prior to the laser ablation, a protective layer is applied to the surface of the polymeric material in which the outlet is to be formed.

26. A method according to any of claims 13 to 18, wherein the polymeric material comprises material curable upon exposure to electromagnetic radiation, and the nozzle is formed by selectively exposing the polymeric material to electromagnetic radiation and removing non-exposed material to form said nozzle.

27. A method according to claim 15, wherein the nozzle is formed at least in part during the moulding of the polymeric material in the aperture.

28. A method according to claim 27, comprising the step of inserting a mould having a profile conforming to that of at least part of the nozzle into the aperture in the body, injecting polymeric material between the mould and the periphery of the aperture in the body, and subsequently removing the mould.

29. A method according to claim 28, wherein a plurality of nozzles are simultaneously formed in the body.

30. A method according to claim 29, wherein each nozzle is formed using a single mould, the mould having a plurality of profiled portions, and wherein each portion is inserted into a respective aperture formed in the body and polymeric material is injected between each profiled portion and the periphery of the respective aperture.

31. A method according to any of claims 29 to 30, wherein the mould includes a substantially planar portion extending about said profiled portion, one or more spacers being located between the planar portion and a surface of the body so that polymeric material is also injected into the space defined between said surface and said planar portion to form a layer of polymeric material on said surface.

32. A method according to any of claims 13 to 31, further comprising the step of forming a liquid-repellant layer extending about said outlet.

33. A method according to claim 13 or 14, wherein a cover plate is mounted over the aperture formed in said body, a layer of polymeric material is subsequently formed within the aperture so as to form a first part of said nozzle, and an aperture substantially co-axial with the nozzle bore is formed in said cover plate to form a second part of said nozzle.

34. A method according to claim 33, wherein the layer of polymeric material is formed using a coating technique.

35. A method according to claim 34, wherein an additional layer of polymeric material is formed on the surface of the cover plate opposite said body.

36. A method according to claim 35, wherein a portion of the additional layer of polymeric material extending about said co-axial aperture is selectively removed following formation of said co-axial aperture.

37. A nozzle plate blank for droplet deposition apparatus, the blank comprising a body having a plurality of apertures formed therein, polymeric material being located in each aperture.

38. A nozzle plate blank according to claim 37, comprising a bore formed partially through the polymeric material to define part of a nozzle within each aperture of said nozzle plate.

39. A nozzle plate blank according to claim 38, wherein the bore is tapered.

40. A nozzle plate blank according to any of claims 37 to 39, wherein the polymeric material comprises one of epoxy resin, parylene, polyimide or a thermoplastic.

41. A nozzle plate blank according to any of claims 37 to 40, wherein the body is formed from one of metallic and ceramic material.

42. A nozzle plate blank according to claim 41, wherein the body is formed from an alloy comprising nickel and iron.

43. A nozzle plate blank according to any of claims 37 to 42, wherein a layer of said polymeric material extends over a bonding surface of the body.

44. A nozzle plate, a nozzle plate blank or droplet deposition apparatus substantially as herein described.

45. A method of manufacturing a nozzle plate for droplet deposition apparatus substantially as herein described.
